(19) United States
(12) Patent Application Publication
(10) Pub. No.: US 2020/0186653 A1
(43) Pub. Date: Jun. 11, 2020

(54) Image Reading Device

(71) Applicant: Konica Minolta, Inc., Tokyo (JP)

(72) Inventors: Kunihiro MIWA, Inazawa-shi (JP); Kazuhiro ISHIGURO, Toyohashi-shi (JP)

(73) Assignee: Konica Minolta, Inc., Tokyo (JP)

(21) Appl. No.: 16/695,495

(22) Filed: Nov. 26, 2019

(30) Foreign Application Priority Data
Dec. 7, 2018 (JP) 2018-230043

(51) Int. Cl. H04N 1/00; G10L 15/22

(52) U.S. Cl. CPC H04N 1/00013; H04N 1/00238; G10L 2015/223; G10L 15/22; H04N 1/00811

(57) ABSTRACT

Disclosed is an image reading device that may include: a first receiver receiving a reading job execution instruction by voice input; a second receiver receiving an instruction to convert first image data into second image data; and a CPU. The CPU may set a value of a setting category required for execution of a reading job to a first selectable value when no instruction is provided by the voice input for the setting category; execute the reading job according to the first selectable value to obtain the first image data; and generate the second image data from the first image data when the instruction to convert the first image data is received. The second image data may be equivalent to image data that would be obtained by the reading job executed according to a second selectable value, and the second image data can be generated from the first image data, but the reverse is not possible.

### CROSS REFERENCE TO RELATED APPLICATIONS

This application claims priority to Japanese Patent Application No. 2018-230043 filed on Dec. 7, 2018, the entire disclosure of which is incorporated herein by reference.

### BACKGROUND

### (1) Technical Field

The present disclosure relates to image reading devices such as scanners that read document images.

### (2) Description of the Related Art

In an image reading device, when a user executes a document image reading job, values for various setting categories can be set such as whether to generate color or monochrome image data, and whether reading resolution is high, medium, or low (for example, see JP 2006-333365).

For each setting category, default values such as monochrome and medium resolution are typically set when a device is shipped from a point of manufacture, and can be changed to other selected values after installation in a user's office, or similar. For example, a value that is frequently used may be set as a default value in advance, and a user can change the setting category to a value other than the default value for each job.

Recently, it has become possible to use a method of receiving voice instructions as input. For example, if a job instruction is given by voice, such as to scan after a document is set, this is easier for the user than pressing an input button while viewing a display screen on an operation panel.

On the other hand, when using a voice input method, typically only setting categories that occur to or are known by the user are set by voice. In the example of an instruction to scan, the only information provided is that the job name is scan, and therefore default values are applied to setting categories for which voice instructions are not provided, such as color or monochrome, resolution, etc., in order to execute the reading job.

For example, if the default resolution value is medium, movement speed of the scanner is set faster than it would be at high resolution, and pixel density is thinned out more than it would be from image data read at high resolution, and medium resolution image data is generated.

However, if a user wants high resolution but inadvertently forgets to specify the resolution, medium resolution image data will be generated, and the user will be unable to get the desired image data after reading.

The user can give an additional voice instruction to “scan, high resolution”, but this causes the job to be redone. If the medium resolution image data could be restored to high resolution, it would not be necessary for the scanner to redo the job of reading the document image, but if the medium resolution image data cannot be restored to high resolution, redoing the job is necessary.

### SUMMARY

The present disclosure has been achieved in view of the above technical problems, and an object of the present disclosure is to describe an image reading device that can acquire image data according to user wishes without needing to redo a reading job.

The above-mentioned object of the present disclosure may be achieved by an image reading device that executes a reading job to read a document, the image reading device comprising: a first receiver that receives a reading job execution instruction by voice input; a second receiver that receives an instruction to convert first image data obtained by the reading job into second image data or an instruction not to convert the first image data; and a central processing unit (CPU). The CPU: sets a value of a setting category that is required for execution of the reading job to a first selectable value when no instruction is provided by the voice input for the setting category, where a plurality of selectable values including the first selectable value and a second selectable value exist for the setting category; executes the reading job according to the first selectable value to obtain the first image data; and generates the second image data from the first image data when the instruction to convert the first image data is received by the second receiver. The second image data is equivalent to image data that would be obtained by the reading job executed according to the second selectable value, and the second image data can be generated from the first image data, but the reverse is not possible.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the disclosure. In the drawings:

FIG. 1 is a perspective view diagram illustrating an overall structure of a multi-function peripheral (MFP) pertaining to an embodiment;

FIG. 2 is a diagram illustrating a schematic structure of a scanner body of an image reader and an automatic document feeder (ADF);

FIG. 3 is a block diagram illustrating a main controller provided to an image reader;

FIG. 4 is a block diagram illustrating a second controller;

FIG. 5 is a diagram illustrating example content of a determination table;

FIG. 6A and FIG. 6B are diagrams illustrating an example of a job management table;

FIG. 7A and FIG. 7B are diagrams illustrating display examples of a confirmation request screen;

FIG. 8 is a block diagram illustrating an image data converter;

FIG. 9 is a flowchart illustrating control of a voice input job execution operation;

FIG. 10 is a flowchart illustrating a document reading operation subroutine;

FIG. 11 is a flowchart illustrating a portion of control of a voice input job execution operation pertaining to a modification.

### DETAILED DESCRIPTION

The following describes an embodiment of an image reading device using the example of a color multi-function peripheral (MFP).

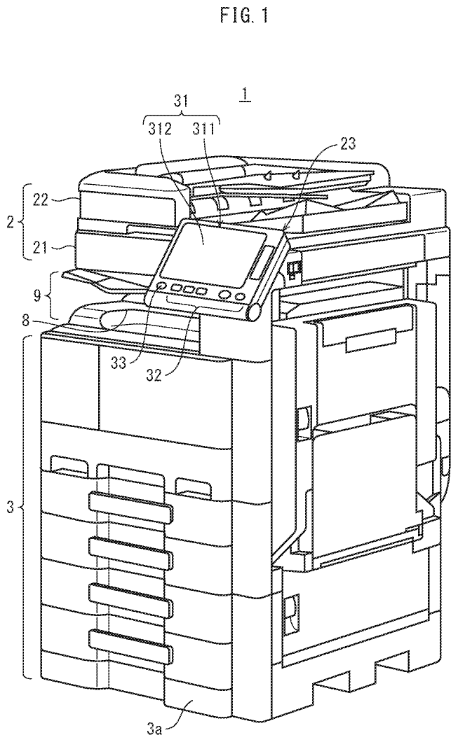

FIG. 1 is a perspective view diagram illustrating an overall structure of an MFP 1.

As illustrated, the MFP 1 includes an image reader 2 and a printer 3 situated below and separated from the image reader 2 by a space 9. The MFP 1 is a multifunction device having scanner, copier, and printer functions.

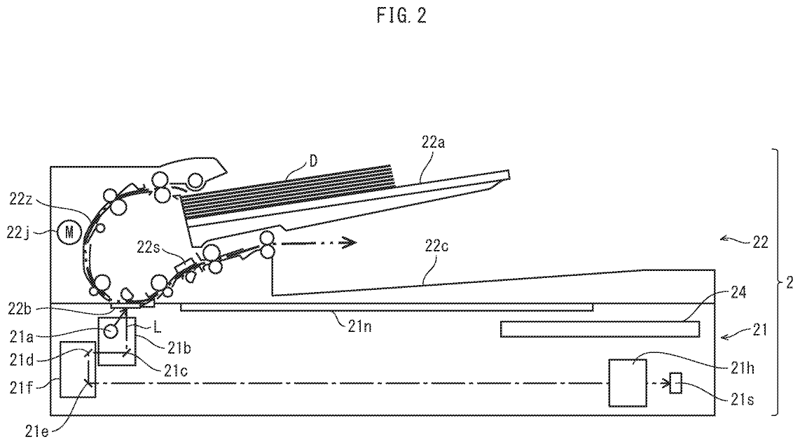

The image reader 2 includes a scanner body 21, an automatic document feeder (ADF) 22, an operation panel 23, and a main controller 24 (see FIG. 2). The image reader 2 is structured such that reading is possible by both a well-known sheet-through method in which both an image of a first side (front surface) and an image of a second side (back surface) of a document fed by the ADF 22 are read by a single fixed optical system, and a scanner movement method in which an image of a first side of a document is read by a single moving optical system.

FIG. 2 is a diagram illustrating a schematic structure of the scanner body 21 and the ADF 22 of the image reader 2.

As illustrated, when a document image is read by the sheet-through method, a document D set on a paper feed tray 22a is fed by the ADF 22, sheet by sheet, along a document conveyance path 22z by conveyance rollers rotated by a drive motor 22j, and each sheet is passed over a glass 22b at a reading position of the scanner body 21 and discharged to a discharge tray 22c.

The scanner body 21 reads an image of a first side (front surface) of the document D when it is conveyed by the ADF 22 to pass over the glass 22b. More specifically, a lamp 21a positioned on a first slider 21b stationary at a position directly below the glass 22b is turned on, causing a light L to irradiate the first side of the document D passing over the glass 22b. The optical path of light reflected from the first side of the document D is changed by a first mirror 21c, and a second mirror 21d and a third mirror 21e of a second slider 21f, to be imaged on a light-reception surface of a charge-coupled device (CCD) sensor 21s (first reading element) by a condenser lens 21h. The CCD sensor 21s outputs a color image signal corresponding to the image of the first side of the document D by photoelectric conversion of the received light.

The image on the second side of the document D is read after the document D being conveyed through the document conveyance path 22z passes over the glass 22b, when the document D passes under a contact image sensor (CIS) 22s (second reading element) disposed in the vicinity of the document conveyance path 22z. The CIS 22s outputs a color image signal corresponding to the image of the second side of the document D.

In the case of a copy job, the outputted color image signals corresponding to the first side and the second side are converted into color or monochrome image data (described later) for printing by the main controller 24, and the image data is sent to the printer 3 for printing. In the case of a scan job, the outputted color signals are converted into a defined format of image data and stored in a storage (not illustrated). Subsequently, the image data is read out when required for use by a user.

On the other hand, when reading a document image by the scanner movement method, the ADF 22 is opened upwards by a user, and while a document is on a platen glass 21n, the lamp 21a is turned on and the first slider 21b is caused to move (to the right in FIG. 2).

When the first slider 21b moves, the second slider 21f moves in the same direction but at half the speed of the first slider 21b. As a result, light reflected from the document is imaged on the light-reception surface of the CCD sensor 21s while a distance (optical path length) from the document on the platen glass 21n to the condenser lens 21h is kept constant.

FIG. 1 illustrates that the operation panel 23 is positioned to be easy for a user to operate, to the front of the image reader 2, and includes a touch panel 31 (second receiver), a hard key group 32, and a microphone 33 (first receiver).

The touch panel 31 includes a liquid crystal display (LCD) 311 and a touch pad 312. On the LCD 311 are displayed various screens and confirmation request screens (described later) for execution of jobs such as copying jobs. The touch pad 312 detects a touch input applied to a button or the like displayed on a display screen of the LCD 311. Although not illustrated, a button or the like may be displayed for the purpose of receiving from a user a selection of a job to be executed, for example.

The hard key group 32 includes a start key for receiving a job execution start instruction from a user, a stop key for receiving a job stop instruction from a user, and the like.

The microphone 33 is disposed next to the hard key group 32, and generates voice data from user voice input. Voice input can be provided, for example, by a user standing in front of the operation panel 23, touching a microphone button (not illustrated) displayed in the LCD 311 to enable voice input, facing the microphone 33, and providing a vocal instruction such as “one copy”.

According to the present embodiment, a user can select a job to be executed or give an instruction to execute a job by touching the touch panel 31, pushing a button of the hard key group 32, or vocalizing with respect to the microphone 33.

The main controller 24 performs processing based on touch input, button presses, and voice instructions, for example executing jobs such as copying and scanning, and switching display screens of the LCD 311.

The printer 3 is a tandem-type color image forming device capable of switching between color and monochrome image forming, in which color images are formed by four colors of toner, yellow (Y), magenta (M), cyan (C), and black (K), and monochrome images are formed by only black (K) toner.

In the case of a copy job, a color image or a monochrome image based on image data generated by the image reader 2 is formed on a recording sheet fed from one of a plurality of paper cassettes 3a, and after the image forming the recording sheet is discharged to and stored on the discharge tray 8.

In the case of a print job, a color image or a monochrome image based on image data sent via a network from an external terminal device (not illustrated) is formed on a recording sheet, after which the recording sheet is discharged to and stored on the discharge tray 8.

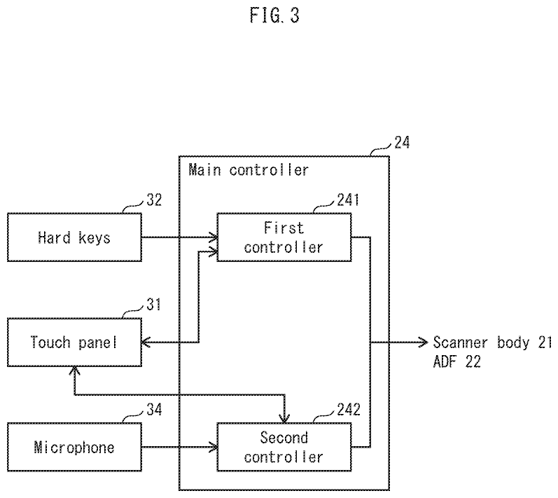

FIG. 3 is a block diagram illustrating the main controller 24.

As illustrated, the main controller 24 includes a first controller 241 and a second controller 242 (central processing unit (CPU)).

The first controller 241 controls the scanner body 21 and the ADF 22 to execute document image reading operations based on touch input to the touch panel 31 and presses of the hard key group 32.

The second controller 242 controls the scanner body 21 and the ADF 22 to execute document image reading operations based on voice data from the microphone 34. The reading operations according to the first controller 241 are the same as that of known structures and therefore not described here. The following is a specific description of reading operations according to the second controller 242.

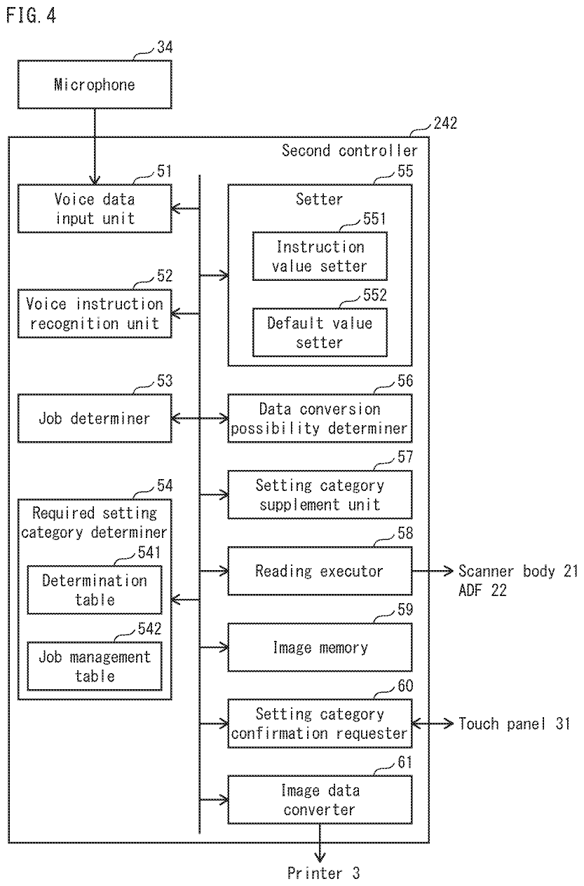

FIG. 4 is a block diagram illustrating the second controller 242.

As illustrated, a voice data input unit 51 of the second controller 242 receives voice data via the microphone 34 connected thereto. The voice instruction recognition unit 52 recognizes what instruction a user has given by converting voice data from the voice data input unit 51 into text data by voice recognition processing, then analyzing the text data.

More specifically, a noise level of the voice data is reduced by using a noise reduction algorithm, then text data is generated by obtaining a word string that maximizes a product of three probability models: an acoustic model obtained by modeling the voice data in phoneme units by using frequency characteristics of the voice data, for example modeling “copy” as “co” and “py”; a pronunciation dictionary defining phonemes that make up words for each word; and a language model defining ease of word connections.

Whether or not the text data generated matches the name of a job or a function registered in advance (copy, scan, color, double-sided, etc.) is determined, and a name that is determined to be a match is recognized as a job name or function name indicated by a user's voice. Voice recognition methods are of course not limited to the example described above, and another method may be used.

A job determiner 53 determines a job name indicated by a user from a recognition result from the voice instruction recognition unit 52. For example, when “copy” is recognized, this is determined to indicate a copy job.

A required setting category determiner 54 has a determination table 541 and a job management table 542, and determines required setting categories to execute a job determined by the job determiner 53, for example a copy job, by referring to the determination table 541 in which such information is registered in advance.

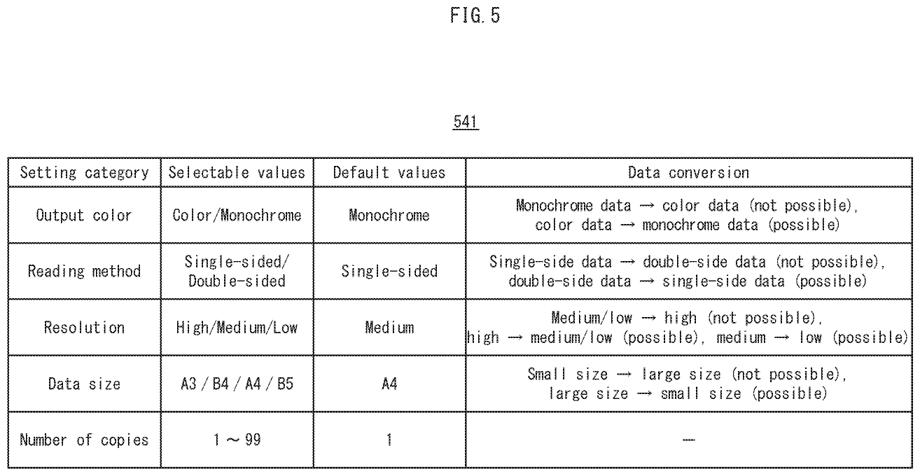

FIG. 5 is a diagram illustrating example content of the determination table 541, with respect to a copy job.

As illustrated, the determination table 541 includes setting categories, and columns corresponding to the setting categories: selectable values, default values, and data conversion.

Executable functions are written in the setting categories column, in this example output color, reading methods, resolution, data size, and number of copies. Each setting category in the setting categories column is a setting category required for execution of a copy job. Accordingly, the required setting category determiner 54 can determine from the settings column of the determination table 541 that the five setting categories from output color to number of copies are setting categories required for execution of a copy job.

In the selectable values column are values that a user can select for corresponding setting categories, for example with respect to “output color”, “color” or “monochrome” can be selected.

In the default values column are values chosen in advance from the selectable values as default values by an administrator or the like. In the example of FIG. 5, the default values are “monochrome”, “single-sided”, “medium” resolution, “A4” size, and “1” copy.

In the data conversion column is information indicating whether or not image data to be generated when a reading operation is executed based on one selectable value among the selectable values can be converted to image data to be generated when a reading operation is executed based on another selectable value.

More specifically, when a selected value is monochrome, image data obtained by a reading operation using the monochrome setting becomes K image data (monochrome data). However, when a selected value is color, image data obtained by a reading operation using the color setting becomes YMCK image data (color data).

Color data includes K image data, and therefore if color data is generated, it can be converted into monochrome data by deleting the YMC color image data. In contrast, monochrome data does not include YMC image data, and therefore if monochrome data is generated, it cannot be converted into color data. In the data conversion column of FIG. 5, (possible) is indicated where conversion is possible and (impossible) is indicated where conversion is not possible.

Regarding reading method, the selectable values indicated are “single-sided” for reading only one side of a document and “double-sided” for reading both sides of a document.

Data conversion between single-sided and double-sided is as follows. When single-sided is selected, image data obtained by a reading operation is image data of only a first side of a document (single-side data), and when double-sided is selected, image data obtained by a reading operation is image data of both a first side and a second side of a document (double-side data). Double-side data includes image data of a first side of a document, and therefore if double-side data is generated, it can be converted into single-side data by deleting image data of a second side. In contrast, single-side data does not include image data of a second side of a document, and therefore if single-side data is generated, it cannot be converted into double-side data.

Regarding resolution, the selectable values of resolutions at which a document is read are indicated as high (for example 600 dpi), medium (for example 300 dpi), and low (for example 100 dpi). Here, dpi indicates dots per inch.

Data conversion when changing resolution is as follows. When a selected value is medium or low, image data obtained by a reading operation is image data at medium or low resolution, and when a selected value is high, image data obtained by a reading operation is image data at high resolution. High resolution image data can be converted into medium or low resolution image data by thinning out pixel density, for example. In contrast, high resolution image data cannot be generated from low or medium resolution image data, and therefore low or medium resolution image data cannot be converted into high resolution image data. That is, conversion of image data is possible from higher to lower resolutions, but not possible from lower to higher resolutions.

Regarding data size, the selectable values of data sizes for reading images are indicated to be A3, B4, A4, and B5. Data sizes for reading images actually indicate the sizes of recording sheets.

Data conversion between data sizes is as follows. For example, when an open A4 size book equivalent to an A3 size document is placed on the platen glass 21n, and a reading operation is executed to read an Nth page and an (N+1)th page, if A3 is selected for data size, a reading operation is executed with respect to an A3 size document, and therefore A3 size image data is generated of an image of the A4 size Nth page and the A4 size (N+1)th page arranged side-by-side. This A3 size image data includes two items of image data—the Nth page and the (N+1)th page.

Thus, after a reading operation, if, for example, a user wants to keep the Nth page and delete the (N+1)th page, an A4 size data portion corresponding to the (N+1)th page is deleted from the A3 size image data obtained by the reading operation, the data size becomes A4 size, and it becomes possible to process the A4 size image data of the Nth page. Further, if downscaling processing is performed, conversion after a reading operation to image data sizes smaller than A3, such as B4 or A4, is possible.

In contrast, when A4 is selected, a reading operation is executed with respect to a document of A4 size, and A4 size image data is obtained. If, for example, a user is unaware that A4 size has been selected and executes a reading operation of an open A4 size book that corresponds to an A3 size document, only one of an Nth page and an (N+1)th page is read, and image data of one page cannot be converted into image data of the other page Thinning out A3 size data to downscale to A4 size data is also not possible.

That is, conversion from larger sizes to smaller sizes of image data is possible, but conversion from smaller sizes to larger sizes of image data is not possible.

Regarding number of copies, selectable values from 1 to 99 are indicated, but changing the selected number of copies has no effect on whether data conversion is possible or not, and therefore no information is recorded in the corresponding data conversion column.

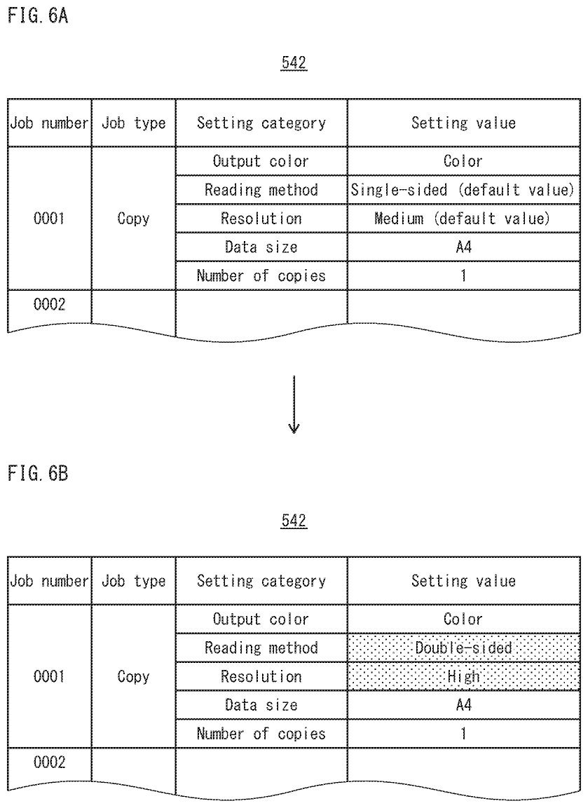

The required setting category determiner 54 writes one or more determined setting categories to the job management table 542. FIG. 6A is a diagram illustrating an example of the job management table 542.

As illustrated, the job management table 542 includes columns for job number, job type, setting categories, and setting values. Job number indicates a number identifying a job to be executed, and job type indicates a job name such as copy or scan.

The setting categories column is a column into which setting categories determined by the required setting category determiner 54 are written, and in this example the five setting categories from output color to number of copies described above have been written. The setting values column includes setting values written by a setter 55, described below.

Returning to FIG. 4, the setter 55 has an instruction value setter 551 and a default value setter 552. The instruction value setter 551 writes (sets) instruction contents to the job management table 542, for setting categories recognized as user instructions by the voice instruction recognition unit 52 among one or more setting categories determined by the required setting category determiner 54.

The default value setter 552 writes a selected value selected by an administrator or the like in the default value column of the determination table 541. Default values may be set and registered at the time of shipping the MFP 1 from the manufacturing factory. Further, after shipping, an administrator may use the touch panel 31 to set default values to desired values. In such a case, the default value setter 552 writes the default values set to the default values column of the job management table 542.

In the example of the job management table 542 illustrated in FIG. 6A, among five setting categories, output color, data size, and number of copies are indicated as being set according to user instructions, and reading method and resolution are indicated as being set according to default values. Default values refer to values written in categories for reading method and resolution in the default values column illustrated in FIG. 5. In the example of settings in FIG. 6A, it is assumed that a voice recognition result is “color copy, A4 size, one copy”. A setting category for which content of a user instruction is set may be distinguished as a setting category A, and a setting category for which a default value is set may be distinguished as a setting category B.

Returning to FIG. 4, a data conversion possibility determiner 56 determines whether or not data conversion is possible with respect to a setting category B of a job registered in the job management table 542. For example, this determination would be made with respect to reading method and resolution of job number 0001, which is a copy job.

This determination is made for each setting category B, by referring to the data conversion column of determination table 541 (FIG. 5) to determine whether or not image data to be generated when a reading operation is executed based on a default value (hereinafter also referred to as “image data α”) can be converted to image data to be generated when a reading operation is executed based on a selectable value other than a default value (hereinafter also referred to as “image data β”).

That is, in the determination table 541, when looking at the data conversion column corresponding to reading method, conversion from single-side data to double-side data is not possible, and conversion from double-side to single-side is possible. Regarding resolution, conversion of image data from medium/low resolution to high resolution is not possible, and conversion of image data from high resolution to medium/low resolution and from medium resolution to low resolution is possible.

In the example of the copy job with the job number 0001, the default value of reading method is single-sided reading, the default value of resolution is medium resolution, and therefore image data α corresponding to default values is medium resolution single-side data, and cannot be converted into (generated as) image data β corresponding to selected values other than default values (for example, double-sided, high resolution), and therefore it is determined that both reading method and resolution cannot be converted. The same determination can be made in the same way for other setting categories such as output color and data sizes.

Returning to FIG. 4, a setting category supplement unit 57 supplements a setting category B for which no voice instruction was received from a user. More specifically, in the job management table 542, among setting categories B, setting values of setting categories for which the data conversion possibility determiner 56 determined that data conversion is not possible are changed from default values to selected values for which data conversion is possible. A setting category that is changed in this way may be distinguished as a setting category C.

In the example of the copy job with the job number 0001, data conversion is determined to be impossible for both reading method and resolution, and therefore, as illustrated in FIG. 6B, reading method and resolution setting values are changed to double-sided and high resolution, respectively.

The reading method is changed to “double-sided” because double-side data obtained by a reading operation can be converted to single-side data (image data to be obtained with the default setting of single-sided). Similarly, resolution is changed to “high” because high resolution image data obtained by a reading operation can be converted to medium resolution (default value) image data.

That is, a setting category C can be said to be a setting category for which, where a first image data to be obtained by a reading operation (reading job) executed according to a first selectable value (for example, double-sided, high resolution) among a plurality of selectable values and a second image data equivalent to image data that would be obtained by a reading operation executed according to a second selectable value (for example, single-sided, medium/low resolution) have a relationship such that the second image data can be generated from the first image data, but the reverse is not possible. The setting category supplement unit 57, when a default value (for example, single-sided, medium or low resolution) for a setting category C belongs to one of the second selectable values described above, sets one of the first selectable values (double-sided, high resolution) instead of the default value.

When the setting category supplement unit 57 finishes changing the setting values, a reading executor 58 refers to the job management table 542 and executes a reading job that is registered and not yet executed. In this example, this means executing the copy job with job number 0001.

The reading executor 58, when executing the copy job with job number 0001, reads “color”, “double-sided”, “high resolution”, and “A4 size” from the setting values column of the job management table 542, then controls the scanner body 21 and the ADF 22 to cause execution of a document reading operation based on the setting values read. Details of processing are described later.

An image memory 59 stores image data obtained by a reading operation.

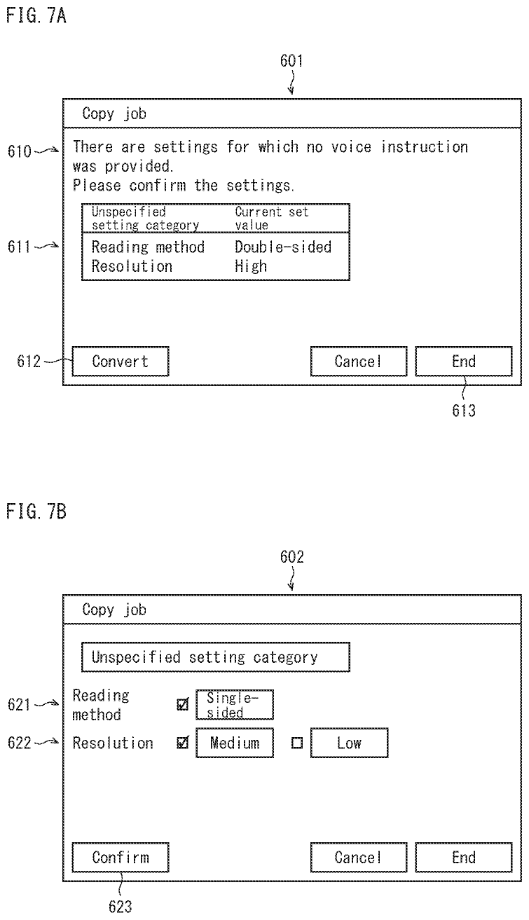

A setting category confirmation requester 60 causes the touch panel 31 to display a confirmation request screen 601 (FIG. 7A) to request that a user confirm a setting value of a setting category C. This is to confirm with the user whether or not an automatically set value for the setting category C is acceptable to the user, as lack of a voice instruction from the user caused a selectable value to be automatically reset for execution of a reading operation, replacing a default value.

As illustrated in FIG. 7A, the confirmation request screen 601 includes a message display field 610 and a confirmation field 611. In the message display field 610, a message is displayed indicating that there is a setting category for which a user has not given a voice instruction for a job the user instructed be executed, in this example a copy job.

In the confirmation field 611 is displayed a name of an unspecified setting category for which no instruction has been given and a current set value. An unspecified setting category is a setting category C subjected to a change by the setting category supplement unit 57, and the current set value is equal to a setting value corresponding to a setting category C registered in the job management table 542, such as the example illustrated in FIG. 6B. The setting category confirmation requester 60 reads the name and setting value of the setting category C from the job management table 542, and causes display of the name and setting value of the setting of the setting category C in the confirmation field 611.

A user can see the confirmation field 611 of the confirmation request screen 601, and if the current setting value (double-sided, high resolution) is acceptable, touch an end button 613, and if a change is desired, touch a change button 612. The setting category confirmation requester 60 sends first instruction information indicating not to convert image data to an image data convertor 61 (illustrated in FIG. 4) when the end button 613 is touched, and switches to display of a setting change reception screen 602 (illustrated in FIG. 7B) when the change button 612 is touched.

The setting change reception screen 602 includes check box fields 621, 622 that allow for touch input of selectable values for each unspecified category. A user can select a desired setting value by touching a check box, causing a check to be displayed, for a selectable value among selectable values displayed in the check box fields 621, 622 for each unspecified category.

Selectable values displayed in the check box fields 621, 622 are selectable values that allow data conversion. More specifically, in this example of setting categories C, for reading method a current selected value is double-sided, double-sided can be data-converted to single-sided, and therefore single-sided is displayed as a selectable value, and for resolution a current selected value is high resolution, high resolution can be data-converted to medium resolution or low resolution, and therefore medium resolution and low resolution are displayed as selectable values.

That is, for setting categories C, selectable values changed from default values, for example double-sided and high resolution (first selectable values) become current setting values, and selectable values that can be converted to from the first selectable values, for example single-sided and medium/low resolution, become selectable values (second selectable values) to be displayed in the check box fields 621, 622. Second selectable values are determined by referring to the data conversion column of the determination table 541.

Note that although the display illustrated in FIG. 7A and FIG. 7B only includes reading method and resolution as unspecified categories, when other setting categories are unspecified, selectable values corresponding to check box fields for the unspecified values are displayed. For example, for output color monochrome becomes a selectable value, and for data size each size smaller than the default value becomes a selectable value.

When the confirmation button 623 is touched, the setting category confirmation requester 60 determines that setting values for which a check is displayed are confirmed, and sends to the image data converter 61 second instruction information indicating conversion of image data to the confirmed setting values.

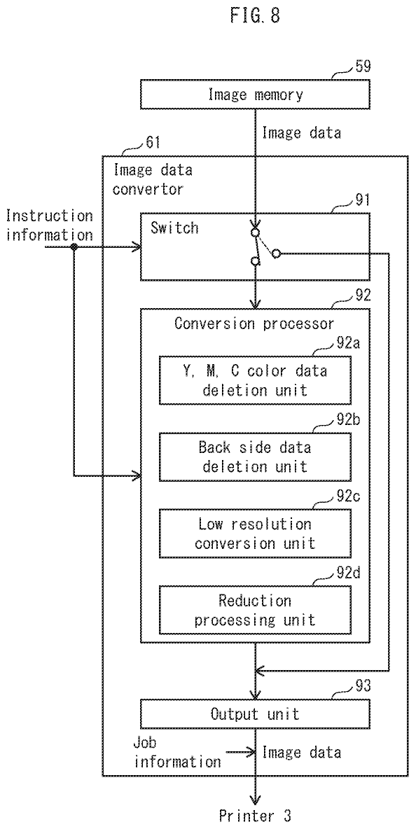

The image data converter 61 includes a switch 91, a conversion processor 92, and an output unit 93, as illustrated in FIG. 8.

The switch 91 switches output destinations of image data from the image memory 59. When the instruction information from the setting category confirmation requester 60 is first instruction information indicating that a user does not wish for image data conversion, the output destination is the output unit 93, and when the instruction information from the setting category confirmation requester 60 is second instruction information indicating image data conversion, the output destination is the conversion processor 92.

The conversion processor 92 executes conversion processing on image data received via the switch 91 from the image memory 59, based on user instruction, then sends converted image data to the output unit 93. The conversion processor 92 includes a Y, M, C color data deletion unit 92a, a back side data deletion unit 92b, a low resolution conversion unit 92c, and a reduction processing unit 92d.

The Y, M, C color data deletion unit 92a performs processing deleting Y, M, C color image data included in color data, leaving only K color image data, when received image data is color data and instruction information from the setting category confirmation requester 60 is an instruction from a user to change to monochrome.

The back side data deletion unit 92b performs processing deleting second side image data included in double-side data, leaving only first side image data, when received image data is double-side data and instruction information from the setting category confirmation requester 60 is an instruction from a user to change to single-sided.

The low resolution conversion unit 92c performs low resolution conversion processing to reduce received image data resolution to medium resolution or low resolution, when instruction information from the setting category confirmation requester 60 is an instruction from a user to convert resolution. This low resolution conversion processing is performed by thinning out pixels as described above.

The reduction processing unit 92d performs processing to cut out part of received image data or scale down received image data to a specified size, when instruction information from the setting category confirmation requester 60 is an instruction from a user to change data size.

Thus, the conversion processor 92 causes operation of any of the Y, M, C color data deletion unit 92a, the back side data deletion unit 92b, the low resolution conversion unit 92c, and the reduction processing unit 92d, based on the second instruction information from the setting category confirmation requester 60. However, for example, when two conversions such as conversion from double-sided to single-sided and conversion to low resolution are to be performed, first the back side data deletion unit 92b is operated, then the low resolution converter 92c is operated. Order of execution of other conversion combinations are also determined in advance.

The output unit 63 sends to the printer 3 image data received via the switch 91 from the image memory 59 (unconverted) and image data received from the conversion processor 92 (converted), in addition to job information indicating each setting value (including size and number of copies) registered in the job management table 542 as setting categories of a copy job.

In this example the printer 3 knows from the job information received from the output unit 63 that the job to be executed is a color, A4 size, one copy job, feeds a recording sheet of the specified size, and prints an image based on received image data onto the recording sheet. Thus, the copy job with job number 0001 is completed.

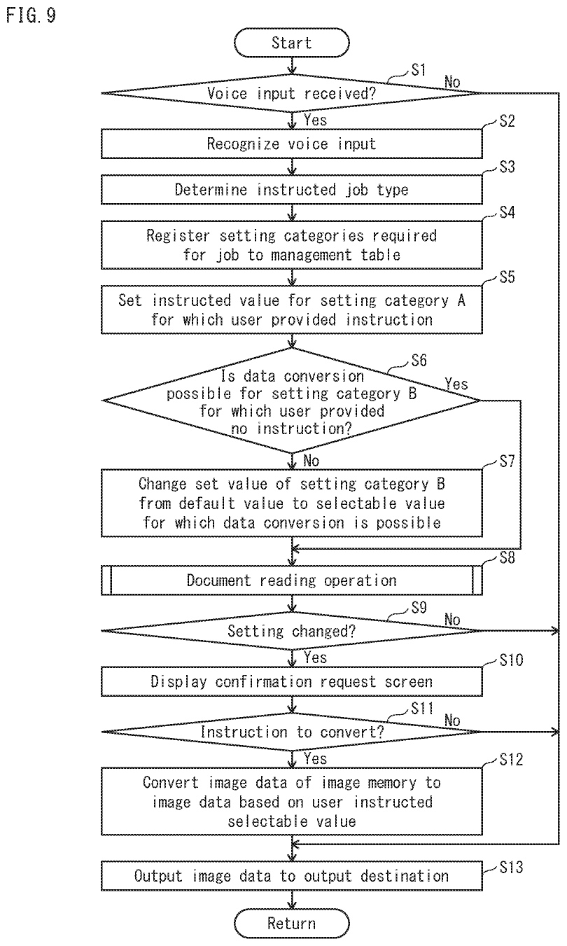

FIG. 9 is a flowchart indicating control of a job execution operation according to voice input. The control is executed by a second controller 242 when called from a main routine (not illustrated) at regular intervals.

As illustrated, when a voice input is accepted (“Yes” in step S1), a voice instruction from a user is recognized (step S2). The voice data input unit 51 accepts voice input, and the voice instruction recognition unit 52 recognizes voice instructions.

A job name specified by a user is determined from a voice instruction recognition result (step S3). This job determination is performed by the job determiner 53.

Setting categories required to execute the job determined are registered in the job management table 542 (step S4). This registration is performed by the required setting category determiner 54.

Next, in the job management table 542, instruction values are set for each setting category A for which a voice instruction from a user has been recognized (step S5). This setting is performed by the setter 55. Next, it is determined whether or not data conversion is possible for each setting category B that remains unspecified by a user (step S6). This determination is performed by the data conversion possibility determiner 56, by referring to the conversion column of the job management table 542 to see whether or not image data α corresponding to a default value can be converted to image data β corresponding to a selectable value other than the default value.

In the above copy job example, monochrome, single-sided, medium resolution, and A4 size are set as default values in the determination table 541 illustrated in FIG. 5. If output color is a setting category B, monochrome data becomes image data α, and color data becomes image data β, and therefore it is determined that data conversion is not possible. Instead, if color is set as a default value, color data becomes image data α, monochrome data becomes image data β, and therefore it is determined that data conversion is possible.

Similarly, if data size is a setting category B, A4 size image data becomes image data α, and if for example A3 size image data becomes image data β, it is determined that data conversion is not possible. Instead, if for example A3 size is set as a default value, A3 size image data becomes image data α, B4 and smaller sizes of image data become image data β, and therefore it is determined that data conversion is possible Similar determination is applied for reading method and resolution.

If it is determined that data conversion is not possible (“No” in step S6), a setting value of a setting category B is changed from a default value to a selectable value allowing data conversion (step S7), then processing proceeds to step S8. This setting change is performed by the setting category supplement unit 57.

On the other hand, if it is determined that data conversion is possible (“Yes” in step S6), step S7 is skipped (not executed), and processing proceeds to step S8. Data conversion is determined to be possible when a default value for a setting category B is color, double-sided, high resolution, or data size A3. In a document reading operation of step S8, the document reading operation is executed based on a current setting value for each setting category.

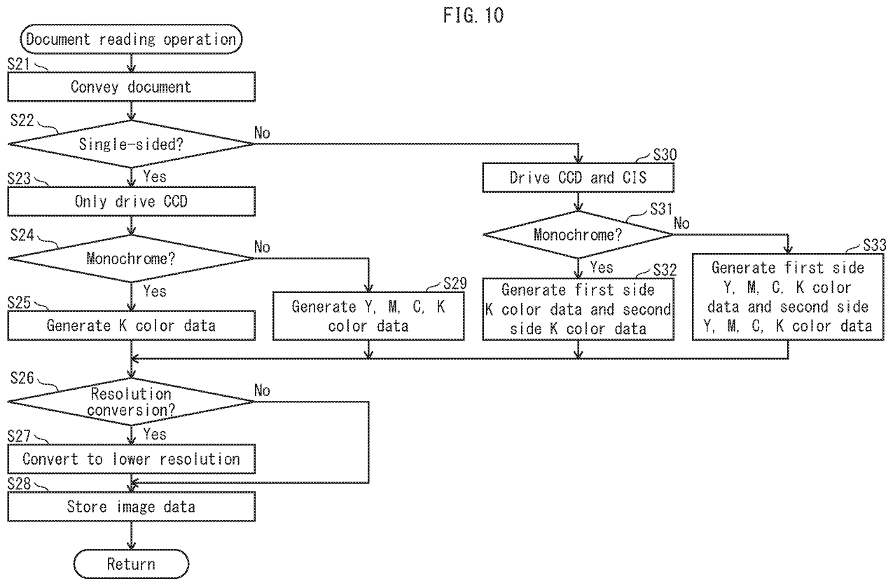

FIG. 10 is a flowchart illustrating content of the document reading operation subroutine, which is performed by the reading executor 58. For example, when a setting value is changed in the copy job with job number 0001, “color”, “double-sided reading”, “high resolution”, and “A4 size” are read out, which are setting values set in the setting values column of the job management table 542 illustrated in FIG. 6B, and a reading operation based on the setting values read out is executed by controlling the scanner body 21 and the ADF 22.

More specifically, as illustrated in FIG. 10, a document D set on the paper feed tray 22a is conveyed one sheet at a time (step S21).

Next, whether or not single-sided reading is to be performed is determined (step S22). This determination is performed by referring to a reading method setting value written to the setting values column of the job management table 542.

If it is determined that single-side reading is to be performed (“Yes” in step S22), the CCD sensor 21s is driven and the CIS 22s is not (step S23). Next, whether or not monochrome reading is to be performed is determined (step S24). This determination is performed by referring to an output color setting value written to the setting values column of the job management table 542.

If monochrome is determined (“Yes” in step S24), when the document D is conveyed past the reading position of the CCD sensor 21a, the CCD sensor 21s reads the document D, and only K color image data is generated based on an image signal of the document D outputted from the CCD sensor 21s (step S25), and processing proceeds to step S26. On the other hand, if color is determined (“No” in step S24), Y, M, C, K color image data is generated based on an image signal outputted from the CCD sensor 21s (step S29), and processing proceeds to step S26.

In step S26, it is determined whether or not a resolution conversion is required. This determination is performed by referring to a resolution setting value written to the setting values column of the job management table 542. In this example, reading resolution of the CCD sensor 21s is fixed, and therefore generated Y, M, C, K image data is read at high resolution, and therefore it is determined that a resolution conversion is not required as long as high resolution is written in the setting values column. If the resolution written in setting values column is medium or low, it is determined that high resolution image data needs to be converted into image data corresponding to medium or low resolution.

If it is determined that resolution conversion is required (“Yes” in step S26), the resolution is converted by, for example, thinning generated Y, M, C, K image data or K image data into image data corresponding to medium or low resolution (step S27), image data after the resolution is stored in image memory 59 (step S28), and processing returns to the routine that called the subroutine. On the other hand, if it is determined that resolution conversion is not required (“No” in step S26), step S27 is skipped, generated Y, M, C, K image data or K image data is not subject to resolution conversion and is stored in the image memory 59 (step S28), and processing returns to the routine that called the subroutine.

In step S22, if it is determined that double-sided reading is to be performed (“No” in step S22), both the CCD sensor 21s and the CIS 22s are driven (step S30). Next, whether or not monochrome reading is to be performed is determined (step S31). This determination is performed in the same way as step S24.

If monochrome is determined (“Yes” in step S31), when the document D is conveyed past the reading position of the CCD sensor 21s, K color image data of the first side is generated based on an image signal of the first side of the document D read by the CCD sensor 21s, and when the document D is conveyed past the reading position of the CIS 22s, K color image data of the second side is generated based on an image signal of the second side of the document D read by the CIS 22s (step S32), and processing proceeds to step S26.

On the other hand, if color is determined (“No” in step S31), Y, M, C, K color image data of the first side is generated based on an image signal of the first side of the document D read by the CCD sensor 21a, and Y, M, C, K color image data of the second side is generated based on an image signal of the second side of the document D read by the CIS 22s (step S33), and processing proceeds to step S26. Processing from step S26 onwards is the same as that of single-sided reading.

Returning to FIG. 9, in step S9, whether or not a setting change was performed in step S7 is determined. When it is determined that a setting change occurred (“Yes” in step S9), the confirmation request screen 601 (FIG. 7A) is displayed on the touch panel 31, and an instruction from a user to change or not change the current setting value of a setting category B is accepted (step S10). Display of the request confirmation screen 601 and acceptance of an instruction from a user is performed by the setting category confirmation requester 60. Note that instead of the confirmation request screen 601, a configuration may be adopted in which an instruction as to whether or not to change a setting value is accepted from a user by voice input, for example. In the present disclosure, the term “second receiver” includes both the confirmation request screen 601 and this alternative configuration that uses voice input.

If it is determined that there is a change instruction (second instruction) from a user (“Yes” in step S11), image data in the image memory 59 is converted into image data based on a selectable value instructed by the user (step S12). This data conversion is performed by the image data convertor 61. Then converted image data is output to an output destination, for example in the case of a copy job, to the printer 3 (step S13), and processing returns to the main routine. Image data sent to the printer 3 is used for printing the image on a recording sheet.

On the other hand, if it is determined that there is an instruction indicating no change (first instruction) from a user (“No” in step S11), step S12 is skipped and processing proceeds to step S13. In this case, unconverted image data is output to an output destination. Further, if it is determined that no setting change occurred (“No” in step S9), processing proceeds to step S13.

Here, a configuration can be adopted in which, prior to outputting image data to the printer 3, a preview display of an image of the image data is displayed on the LCD 311. A user can view the preview display to check a finished state of printed output before printing. In this case, the image data is output to the printer 3 when an instruction to end the preview display is received from a user.

If a cancel button (not illustrated) for instruction cancellation of printing is provided along with the preview display, if a user wants to cancel printing as a result of viewing the preview display, the user can instruct cancellation of printing by using the cancel button.

Note that although in the case of a copy job the output destination of image data is the printer 3, in the case of a scanning job, for example, when a storage that stores read image data is specified, such as a storage device with a hard disk, the storage can be the output destination. Further, when a facsimile transmission job execution function is provided, a facsimile transmitter that faxes an image to a partner destination via a network such as a telephone line can be used as an output destination.

According to the embodiment described above, for each job for which a user has provided an execution instruction by voice input, for a setting category B for which no user instruction has been provided, a default value is automatically changed to a selectable value that allows data conversion (generation) after a reading operation, prior to starting the reading operation.

As a result, for example, when a user provides an instruction to execute a copy job by voice input, and the instruction is intended to be for double-sided reading to copy each side of a document to separate recording sheets, but only “copy” is vocalized, even if a default value is set for single-sided reading of only one side of the document, a double-sided reading operation is executed. This is because prior to the reading operation the setting is automatically switched to double-sided reading that generates double-side data that can be converted to single-side data.

Then, after completion of double-sided reading, the confirmation request screen 601 requesting confirmation of whether to convert from double-side image data to the default value of single-side image data is displayed. From the confirmation request screen 601, a user can select whether to leave the image data as is, based on the automatically set double-sided reading, or to convert the image data, based on the default value of single-sided reading.

Accordingly, even if a user forgets a double-sided reading instruction when providing voice input, double-sided scanning is actually executed, making it unnecessary to redo a double-sided job after the job is executed. On the other hand, a user that does not provide instruction by voice because single-sided reading is the default value can instruct that image data generated by double-sided reading be converted to image data according to single-sided reading, and therefore a copy job based on image data according to single-sided reading can be executed.

The present disclosure is not limited to image reading devices, and includes document image reading methods. Further, a method may be a program executable by a computer. Further, a program may be recorded on a computer-readable storage medium such as a magnetic disk such as a magnetic tape or flexible disk, an optical storage medium such as a digital versatile disc read-only memory (DVD-ROM), digital versatile disc random-access memory (DVD-RAM), compact disc read-only memory (CD-ROM), compact disc recordable (CD-R), magnetic optical (MO), Phase-change Dual (PD), a flash memory storage medium, or the like. Such a program may be produced, transferred, etc., in the form of the storage medium, or may be transmitted and supplied via a wired or wireless network such as the Internet, broadcasting, telecommunication lines, satellite communication, or the like. Further, processes of the embodiment described may be performed by software, and may be performed by using hardware circuitry.

### <Modifications>

A description has been provided based on an embodiment, but of course the present disclosure is not limited to the embodiment described above, and includes the following modifications.

(1) According to an embodiment, color, monochrome, single-sided, double-sided, etc., are included in setting categories, but the present disclosure is not limited to these examples. Gain adjustment may be included.

Gain adjustment is a known process for correcting tone values of image data so that, for example, red color of a document image is reproduced in a darker color or a lighter color according to a user instruction. A user can specify intensity correction by a numerical value, for example. More specifically, for example when 100 is a reference value, a numerical value greater than 100 is darker and a lower value is lighter.

If gain adjustment is performed, then typically tone values prior to the gain adjustment cannot be restored. Thus, gain adjustment is a setting category that has a relationship such that image data obtained from a reading job executed with a setting that gain adjustment is not performed (first image data) can be used to generate image data obtained from a reading job executed with a setting that gain adjustment is performed (second image data), but not vice-versa.

Accordingly, if a voice instruction from a user does not include gain adjustment and a default value is set to perform gain adjustment, a reading operation is executed after automatically switching to a setting with no gain adjustment. Subsequently, when specification of a numerical value for gain adjustment is received from a user via the confirmation selection screen 601, the user can obtain desired image data through application of the specified gain adjustment to the image data obtained by the reading operation. One or more setting categories may be provided.

(2) According to an embodiment, a notification that a setting value is automatically set instead of a default value for a setting category C appears on a screen display via the confirmation request screen 601 illustrated in FIG. 7A, but the present disclosure is not limited to this example. For example, a sound output configuration can be adopted in which a sound indicating this setting is outputted from a speaker or the like.

(3) According to an embodiment, among setting categories if output color (color/monochrome) belongs to a setting category B for which no user voice instruction has been provided, and a default value is set to monochrome, the setting category is automatically set to color then a reading operation is executed, but the present disclosure is not limited to this.

A configuration may be adopted in which, for example, in an environment in which color output is generally prohibited by an administrator of the MFP 1, priority is given to the prohibition of color output by the administrator, and output color that is a setting category B is not changed from monochrome to color (change is prohibited).

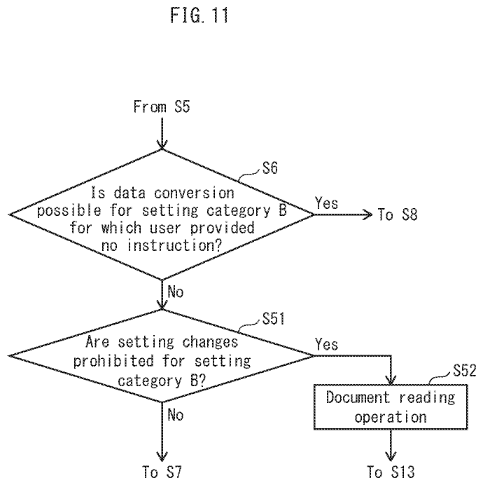

FIG. 11 is a flowchart illustrating prohibition processing pertaining to this modification, in which only a portion changed from the flowchart illustrated in FIG. 9 is shown. As illustrated in FIG. 11, when it is determined that data conversion is not possible for a setting category B (“No” in step S6), it is determined whether or not changing this setting category B has been prohibited (step S51).

This determination is made by referring to prohibition information stored in a storage (not illustrated) of the second controller 242. The prohibition information indicates whether or not changing a selectable value is prohibited for each setting category B, and is registered in advance by an administrator or the like. In the example above, among the setting categories, only changing output color (color/monochrome) is prohibited.

If it is determined that the setting category B is not prohibited from being changed (“No” in step S51), processing proceeds to step S7. In this case, processing is the same as that of an embodiment described above. On the other hand, if it is determined that the setting category B is prohibited from being changed (“Yes” in step S51), the document reading operation is executed (step S52). This document reading operation is basically the same operation as the document reading operation illustrated in FIG. 10, but color reading is not executed.

After executing the document reading operation (step S52), steps S7 to S12 are skipped and processing proceeds to step S13. Change to color is prohibited, and therefore image data is outputted without performing a process of receiving a conversion instruction from a user via display of the confirmation selection screen 601 of step S10.

Thus, if a condition that change is not performed (prohibition) is applied to a setting category (output color), conversion to color will not be accepted from general users, and management according to an instruction of an administrator who prohibits color printing becomes possible.

The above describes prohibiting change of output color (color/monochrome) among setting categories for the purpose of prohibiting color copying in view of costs, but the present disclosure is not limited to this example, and prohibition may be applied to other setting categories.

(4) According to an embodiment, an example is described in which an image reading device is applied to a scanner capable of double-sided reading and color reading of a document, but the present disclosure is not limited to this example. The present disclosure can also be applied to a structure capable of reading an image on only one side of a document and a structure capable of reading only in monochrome.

Further, the example of the MFP 1 including the image reader 2 and the printer 3 has been described, but the present disclosure can also be applied to the structure of only the image reader 2. In the case of only the image reader 2, i.e., a scanner, image data obtained from a reading job can be output to an integrated storage and stored, output to another terminal device via a network and stored, or the like.

Further, contents of any described embodiment and modification may be combined in any possible combination.

### <Review>

The content of embodiments and modifications described above illustrate one aspect for solving a technical problem described under “(2) Description of the Related art”, and can be summarized as follows.

An image reading device pertaining to at least one embodiment of the present disclosure is an image reading device that executes a reading job to read a document, the image reading device comprising: a first receiver that receives a reading job execution instruction by voice input; a second receiver that receives an instruction to convert first image data obtained by the reading job into second image data or an instruction not to convert the first image data; and a central processing unit (CPU). The CPU: sets a value of a setting category that is required for execution of the reading job to a first selectable value when no instruction is provided by the voice input for the setting category, where a plurality of selectable values including the first selectable value and a second selectable value exist for the setting category; executes the reading job according to the first selectable value to obtain the first image data; and generates the second image data from the first image data when the instruction to convert the first image data is received by the second receiver. Further, the second image data is equivalent to image data that would be obtained by the reading job executed according to the second selectable value, and the second image data can be generated from the first image data, but the reverse is not possible.

According to the image reading device pertaining to at least one embodiment, the second receiver generates a visual or audio or audiovisual notification notifying a user that the reading job has been executed with the first selectable value set, and the second receiver receives the instruction to convert the first image data or the instruction not to convert the first image data after the notification.

According to the image reading device pertaining to at least one embodiment, the CPU outputs the second image data to an output destination upon reception of the instruction to convert the first image data and outputs the first image data to the output destination upon reception of the instruction not to convert the first image data.

According to the image reading device pertaining to at least one embodiment, the image reading device further includes a display that displays a preview image of image data before the output to the output destination.

According to the image reading device pertaining to at least one embodiment, the CPU does not set the setting category to the first selectable value from a default value when the setting category for which no instruction is provided by the voice input is a setting category previously prohibited from being changed from the default value.

According to the image reading device pertaining to at least one embodiment, the setting category is a resolution setting category for setting a resolution among different resolutions when reading a document, and the first selectable value is a first resolution, and the second selectable value is a second resolution smaller than the first resolution.

According to the image reading device pertaining to at least one embodiment, the setting category is a reading method setting category for setting a reading method: single-sided reading reads only one of a first side and a second side of a document to generate single-side data, and double-sided reading reads both the first side and the second side of a document to generate double-side data, and the first selectable value is the double-sided reading and the second selectable value is the single-sided reading.

According to the image reading device pertaining to at least one embodiment, the setting category is an output color setting category for setting colors read: color reading generates image data of a plurality of colors, and monochrome reading generates image data of only one color among the plurality of colors, and the first selectable value is the color reading and the second selectable value is the monochrome reading.

According to the image reading device pertaining to at least one embodiment, the setting category is a data size setting category for setting a data size among a plurality of different data sizes when the data size for reading a document can be selected from different data sizes, where the data size corresponds to a physical size of the document to be read, and the first selectable value is a first data size and the second selectable value is a second data size smaller than the first data size.

According to the image reading device pertaining to at least one embodiment, the setting category is a gain adjustment setting category for setting whether or not to perform gain adjustment for correcting a tone value of image data, and the first selectable value is a setting of not performing the gain adjustment and the second selectable value is a setting of performing the gain adjustment.

According to the structure described above, image data according to user wishes can be obtained without redoing a reading job.

Although one or more embodiments of the present disclosure have been described and illustrated in detail, the disclosed embodiments are made for the purposes of illustration and example only and not limitation. The scope of the present disclosure should be interpreted by the terms of the appended claims.

As used herein, the words “can” and “may” are used in a permissive (i.e., meaning having the potential to), rather than mandatory sense (i.e., meaning must). The words “include,” “includes,” “including,” and the like mean including, but not limited to. Similarly, the singular form of “a” and “the” include plural references unless the context clearly dictates otherwise. And the term “number” shall mean one or an integer greater than one (i.e., a plurality).

What is claimed is:

1. An image reading device that executes a reading job to read a document, the image reading device comprising:
a first receiver that receives a reading job execution instruction by voice input;
a second receiver that receives an instruction to convert first image data obtained by the reading job into second image data or an instruction not to convert the first image data; and
a central processing unit (CPU) that:
sets a value of a setting category that is required for execution of the reading job to a first selectable value when no instruction is provided by the voice input for the setting category, where a plurality of selectable values including the first selectable value and a second selectable value exist for the setting category;
executes the reading job according to the first selectable value to obtain the first image data; and
generates the second image data from the first image data when the instruction to convert the first image data is received by the second receiver,
wherein the second image data is equivalent to image data that would be obtained by the reading job executed according to the second selectable value, and
wherein the second image data can be generated from the first image data, but the reverse is not possible.

2. The image reading device of claim 1, wherein the second receiver generates a visual or audio or audiovisual notification notifying a user that the reading job has been executed with the first selectable value set, and wherein the second receiver receives the instruction to convert the first image data or the instruction not to convert the first image data after the notification.

3. The image reading device of claim 1, wherein the CPU outputs the second image data to an output destination upon reception of the instruction to convert the first image data and outputs the first image data to the output destination upon reception of the instruction not to convert the first image data.

4. The image reading device of claim 3, further comprising:
a display that displays a preview image of image data before the output to the output destination.

5. The image reading device of claim 1, wherein the CPU does not set the setting category to the first selectable value from a default value when the setting category for which no instruction is provided by the voice input is a setting category previously prohibited from being changed from the default value.

6. The image reading device of claim 1, wherein the setting category is a resolution setting category for setting a resolution among different resolutions when reading a document,
wherein the first selectable value is a first resolution, and
wherein the second selectable value is a second resolution smaller than the first resolution.

7. The image reading device of claim 1, wherein the setting category is a reading method setting category for setting a reading method,
wherein single-sided reading reads only one of a first side and a second side of a document to generate single-side data,
wherein double-sided reading reads both the first side and the second side of a document to generate double-side data, and
wherein the first selectable value is the double-sided reading and the second selectable value is the single-sided reading.

8. The image reading device of claim 1, wherein the setting category is an output color setting category for setting colors read,
wherein color reading generates image data of a plurality of colors,
wherein monochrome reading generates image data of only one color among the plurality of colors, and
wherein the first selectable value is the color reading and the second selectable value is the monochrome reading.

9. The image reading device of claim 1, wherein the setting category is a data size setting category for setting a data size among a plurality of different data sizes when the data size for reading a document can be selected from different data sizes,
wherein the data size corresponds to a physical size of the document to be read, and
wherein the first selectable value is a first data size and the second selectable value is a second data size smaller than the first data size.

10. The image reading device of claim 1, wherein the setting category is a gain adjustment setting category for setting whether or not to perform gain adjustment for correcting a tone value of image data, and
wherein the first selectable value is a setting of not performing the gain adjustment and the second selectable value is a setting of performing the gain adjustment.
